(19) United States
(12) Patent Application Publication
(10) Pub. No.: US 2022/0274143 A1
(43) Pub. Date: Sep. 1, 2022

(54) DUST SOLIDIFICATION SYSTEM AND DUST SOLIDIFICATION METHOD

(71) Applicant: SINTOKOGIO, LTD., Nagoya-shi (JP)

(72) Inventors: Takashi SUZUKI, Nagoya-shi (JP); Yoshihiko OGI, Nagoya-shi (JP); Koh SAITO, Nagoya-shi (JP); Shintaro NISHIKAWA, Nagoya-shi (JP); Yoshiyuki HAYASHI, Nagoya-shi (JP); Masanori UCHIDA, Nagoya-shi (JP); Noriaki MASAKI, Nagoya-shi (JP)

(73) Assignee: SINTOKOGIO, LTD., Nagoya-shi, Aichi (JP)

(21) Appl. No.: 17/677,167

(22) Filed: Feb. 22, 2022

(30) Foreign Application Priority Data
Feb. 26, 2021 (JP) 2021-029641
Jan. 26, 2022 (JP) 2022-009770

(51) Int. Cl. B09B 3/32; B01D 46/00; B09B 3/38

(52) U.S. Cl. CPC B09B 3/32; B01D 46/0043; B09B 3/38; B01D 2273/30

(57) ABSTRACT

A dust solidification system includes: a preduster for sucking dust with a negative pressure generated by a negative pressure generating source, removing solidification-inhibiting substances from the dust, and making the dust with a reduced solidification-inhibiting substance content rate flow toward the source; a dust capturing mechanism for capturing the dust flowing from the preduster and allowing the dust to fall; a storage tank for storing the dust captured by and falling from the capturing mechanism; and a dust solidifying mechanism for solidifying the dust in a forming chamber; and further includes one or more of the following: a dust re-scattering prevention mechanism for preventing re-scattering of the dust falling from the capturing mechanism; a stirring mechanism for stirring the dust loaded into the solidifying mechanism; and an air releasing mechanism for preventing air from entering the forming chamber by releasing air flowing into the storage tank from the solidifying mechanism.

### TECHNICAL FIELD

The present invention relates to a dust solidification system and a dust solidification method.

### BACKGROUND

Fumes generated during laser processing, plasma processing, and welding, etc. of metallic materials and the like can cause serious health hazards if inhaled by workers.

Therefore, in order to keep the working environment clean, a dust collecting device is operated to remove the dust from the working environment.

The dust collected in the dust collecting device is in a state of low bulk density, and since it is difficult to handle dust in this state, the dust is compressed, solidified, and processed into a state (e.g., pellet form) that is easy to handle.

Dust that has been processed into this easy-to-handle state becomes reusable by carrying out a treatment such as remelting.

Patent Document 1, which is an example of conventional art, discloses the technology of compressing and solidifying dust collected by a dust collector inside a predust box.

### CITATION LIST

### Patent Literature

Patent Document 1: JP 2000-140799 A

### SUMMARY OF INVENTION

### Technical Problem

However, the formability of dust containing chips, fine particles, etc. has room for improvement.

The present invention was made in view of the above and has the purpose of improving the formability of collected dust.

### Solution to Problem

One aspect of the present invention that solves the above problem and achieves the purpose is a dust solidification system for solidifying dust containing a fume and a solidification-inhibiting substance that has a greater mass and size than the fume.

This dust solidification system comprises: a preduster for sucking dust with a negative pressure generated by a negative pressure generating source, removing the solidification-inhibiting substance from the sucked dust, and making the dust with a reduced solidification-inhibiting substance content rate flow toward the negative pressure generating source; a dust capturing mechanism for capturing the dust flowing from the preduster due to the negative pressure and allowing the dust to fall; a storage tank for storing the dust captured by and falling from the dust capturing mechanism; and a dust solidifying mechanism for solidifying the dust in a forming chamber.

Moreover, this dust solidification system further comprises one or more of the following mechanisms (1)-(3):

(1) a dust re-scattering prevention mechanism for preventing re-scattering of the dust falling from the dust capturing mechanism;
(2) a stirring mechanism for stirring dust loaded into the dust solidifying mechanism;
(3) an air releasing mechanism for preventing air from entering the forming chamber by releasing air flowing into the storage tank from the dust solidifying mechanism due to the negative pressure.

According to the dust solidification system of the above configuration, it is possible to relatively decrease the content of the solidification-inhibiting substance by removing, with the preduster, the solidification-inhibiting substance that inhibits solidification.

As a result thereof, the formability of the dust is improved.

In one embodiment of the present invention, the dust re-scattering prevention mechanism comprises a plurality of re-scattering prevention units disposed adjacently in a direction traversing the direction in which the dust falls from the dust capturing mechanism, in which each of the plurality of re-scattering prevention units comprises a pair of plate bodies joined in an inverted V-shape in a side view and is disposed with a ridge line portion, formed by the joining of the pair of plate bodies, facing the dust capturing mechanism above, and in which a portion along a lower edge of the plate bodies is provided with a slit to allow dust to pass through downward.

This can suppress upward scattering inside the device of dust that tends to re-scatter when stirred with the stirring mechanism.

In one embodiment of the present invention, the dust re-scattering prevention mechanism further comprises an inclined side wall outside the plate bodies included in the outermost located re-scattering prevention unit among the plurality of re-scattering prevention units, in which a slit is provided between the lower edges of the plate bodies included in the re-scattering prevention units adjacent to one another and between the outermost located re-scattering prevention unit and the inclined side wall.

The slit allows dust that falls from the outermost side to pass through downward.

In one embodiment of the present invention, the dust re-scattering prevention mechanism comprises an upper re-scattering prevention unit group and a lower re-scattering prevention unit group, which are formed by a plurality of re-scattering prevention units, in which each re-scattering prevention unit in the lower re-scattering prevention unit group has a ridge line portion that in a plan view, is disposed within a slit formed in the upper re-scattering prevention unit group.

This can suppress upward re-scattering of dust from the stirring mechanism.

Another aspect of the present invention relates to a dust solidification method.

The dust solidification method includes: sucking dust with a negative pressure generated by a negative pressure generating source, removing solidification-inhibiting substances from the sucked dust, and making the dust with a reduced solidification-inhibiting substance content rate flow toward the negative pressure generating source; capturing the dust flowing due to the negative pressure and allowing the dust to fall; storing the captured and falling dust in a storage tank; and solidifying the dust by a dust solidifying mechanism in a forming chamber.

Moreover, this dust solidification system further includes one or more of the following (1)-(3):

(1) preventing re-scattering of falling dust by a dust re-scattering prevention mechanism;
(2) stirring dust loaded into the dust solidifying mechanism;
(3) preventing air from entering the forming chamber by releasing air flowing into the storage tank from the dust solidifying mechanism due to the negative pressure.

According to the dust solidification method above, the solidification-inhibiting substance content rate can be relatively decreased by a preduster, so the formability of the dust when being solidified in the forming chamber can be improved.

### Effects of Invention

The present invention provides the effect of being capable of improving the formability of collected dust.

### BRIEF DESCRIPTION OF DRAWINGS

FIG. 1 illustrates a schematic configuration of a dust solidification system according to the present embodiment.

FIG. 2 illustrates the preduster in FIG. 1.

FIG. 3 illustrates the dust capturing mechanism, the dust re-scattering prevention mechanism, and the storage tank in FIG. 1.

FIG. 4 provides an enlarged view of a part of the dust re-scattering prevention mechanism shown in FIG. 3.

FIG. 5 illustrates the stirring mechanism and the dust solidifying mechanism in FIG. 1.

FIG. 6 illustrates the stirring mechanism, the dust solidifying mechanism, and the air releasing mechanism in FIG. 1.

### DESCRIPTION OF EMBODIMENTS

An example of the dust solidification system according to the present invention will be described with reference to the drawings.

However, the present invention is not to be construed as being limited by the description of the embodiment below.

### EMBODIMENTS

Below are exemplary explanations relating to a situation in which dust generated from a laser processing machine is solidified.

This dust contains fine fumes and coarse spatter.

Fumes are easy to compress and solidify.

Spatter is greater in mass and size than fumes and is difficult to solidify.

Spatter is an example of a solidification-inhibiting substance that inhibits the formability of dust during solidification thereof into a pellet shape.

Accordingly, when the generated dust (containing fine fumes and coarse spatter) is solidified, the content rate of the fine fumes needs to be increased.

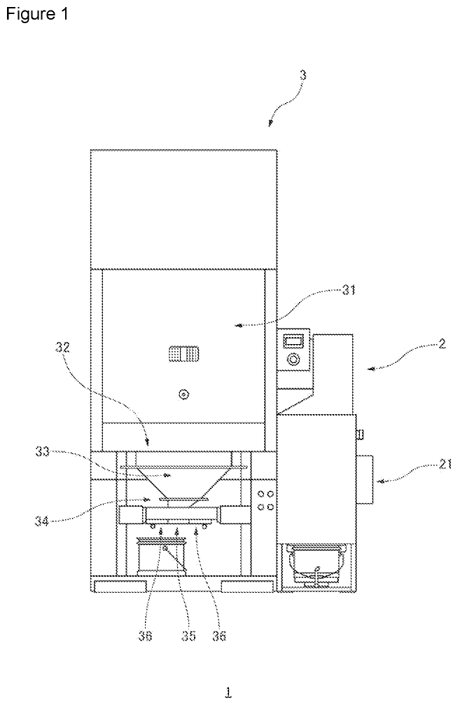

FIG. 1 illustrates a schematic configuration of a dust solidification system 1 according to the present embodiment.

The dust solidification system 1 shown in FIG. 1 comprises: a preduster 2 for classifying sucked dust and removing solidification-inhibiting substances; and a dust collector 3 comprising components in a housing.

The dust collector 3 comprises: a dust capturing mechanism 31; a dust re-scattering prevention mechanism 32; a storage tank 33; a stirring mechanism 34; a dust solidifying mechanism 35; and an air releasing mechanism 36.

The dust solidification system 1 collects dust.

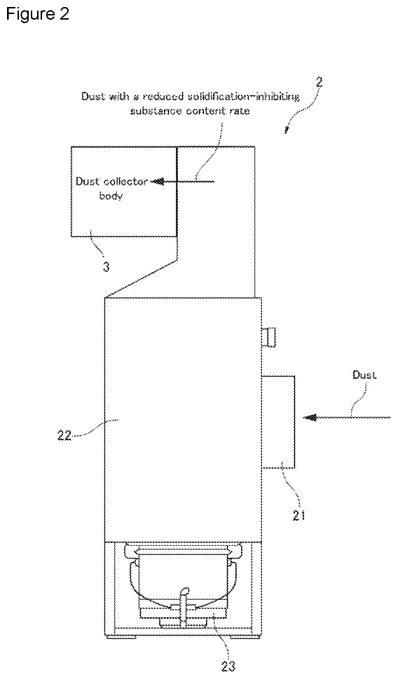

FIG. 2 illustrates the preduster 2 in FIG. 1.

The preduster 2 is disposed on a side of the dust collector 3 and comprises: a dust introduction port 21 for sucking and introducing dust from an outside dust generation source; and a classifying unit 22 for classifying the dust introduced from the dust introduction port 21 and removing solidification-inhibiting substances.

The dust introduction port 21 is connected to a duct, which is not shown and extends to the dust generation source, and the dust introduction portion 21 sucks dust by a negative pressure generated by a negative pressure generating source in the dust collector 3.

The classifying unit 22 removes solidification-inhibiting substances from the sucked dust to reduce the solidification-inhibiting substance content rate and makes the dust with a reduced solidification-inhibiting substance content rate flow toward the dust collector 3.

The movement of the dust in the preduster 2 is caused by the negative pressure suction force generated by driving the negative pressure generating source provided in the dust capturing mechanism 31 inside the dust collector 3.

When the spatter content rate in the dust introduced into the dust collector 3 is high, the formability of the dust during solidification thereof into a pellet shape in the dust collector 3 is reduced.

The preduster 2, by classifying the fumes and the spatter in the sucked dust, reduces the spatter content rate in the dust to a predetermined proportion (or less) and makes the dust flow toward the dust collector 3.

Due thereto, the spatter content rate in the dust introduced into the dust collector 3 can be reduced and the formability of the dust during solidification thereof into a pellet shape in the dust collector 3 can be improved.

Further, the preduster 2 also removes steel plates, etc. of several millimeters or more that have been mistakenly sucked.

Accordingly, with the preduster 2, entry of mistakenly sucked substances into the dust collector 3 can be prevented, and abnormal stops due to jamming of mistakenly sucked substances during dust solidification in the dust collector 3, damage to the dust collector 3, etc. can be prevented.

With the preduster 2, for example, when the dust sucked into the dust introduction port 21 has 50% spatter and 50% fumes, the dust flowing toward the dust collector 3 can be made 20% spatter and 80% fumes.

A solidification-inhibiting substance collecting unit 23, located beneath the classifying unit 22, collects solidification-inhibiting substances such as spatter that have been removed by and fallen from the classifying unit 22.

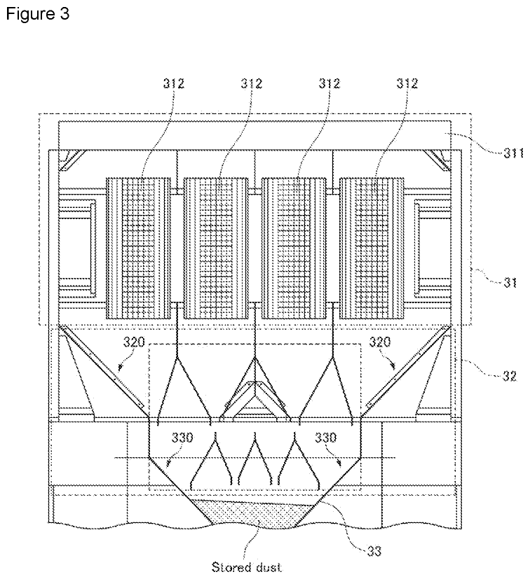

FIG. 3 illustrates the dust capturing mechanism 31, the dust re-scattering prevention mechanism 32, and the storage tank 33 in FIG. 1.

The dust capturing mechanism 31 is provided in an upper portion of the dust collector 3, captures dust flowing from the preduster 2, and allows the dust to fall.

The dust capturing mechanism 31 comprises: a fan 311 that is a negative pressure generating source for generating a negative pressure in an upper portion of the dust collector 3; a filter 312 for capturing dust introduced from the preduster 2; and a dust sweeping mechanism (not shown) for scraping off dust that has adhered to the filter 312.

The dust that has adhered to the filter 312 is scraped off by the unshown dust sweeping mechanism, and the dust that has separated from the filter 312 falls by its own weight.

In addition, when the dust that has adhered to the filter 312 peels off by its own weight over time, a dust sweeping mechanism does not need to be provided.

Here, the sweeping of the dust that has adhered to the filter 312 is regularly performed with the fan 311 in an operating state.

However, even when the fan 311 is in a halted state, the sweeping of the dust that has adhered to the filter 312 may be performed.

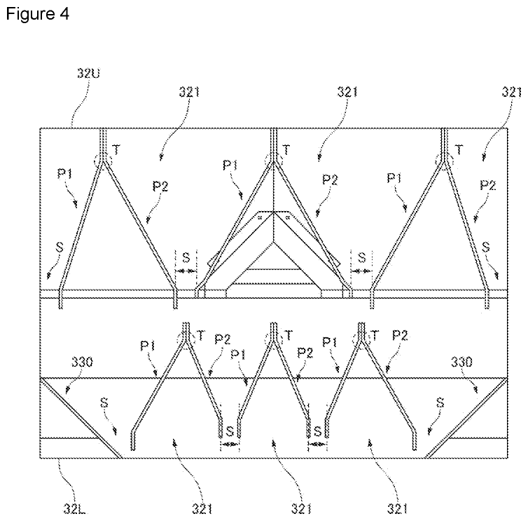

FIG. 4 provides an enlarged view of a part of the dust re-scattering prevention mechanism 32 shown in FIG. 3.

When the scraping-off of the dust that has adhered to the filter 312 is performed with the fan in an operating state, as mentioned above, the relatively light-weight fumes, due to the air flow from beneath generated by the fan 311, whirls up and gets re-scattered.

The dust re-scattering prevention mechanism 32, by blocking the air flow from beneath, prevents the dust falling from the dust capturing mechanism 31 from flowing reversely due to upward re-scattering of the dust.

The dust re-scattering prevention mechanism 32 may be omitted when there is little influence or no reverse flow due to dust re-scattering.

The dust re-scattering prevention mechanism 32 comprises: an inclined side wall 320; and a plurality of re-scattering prevention units 321.

The re-scattering prevention units 321 are disposed adjacent to one another in a direction traversing the direction in which the dust from the dust capturing mechanism 31 falls.

The re-scattering prevention units 321 comprise a pair of plate bodies P1, P2 that extend in the depth direction in FIG. 4 and are joined to form a gable shape, i.e., joined to form an inverted V-shape in a side view, forming a top T comprising a ridge line portion.

The ridge line portions formed by joining pairs of plate bodies P1, P2 are disposed facing the dust capturing mechanism 31 above and in a state roughly parallel to one another.

In a portion along a lower edge of the pair of plate bodies P1, P2, a slit S is provided to allow dust to pass through downward.

The width of the slit S may be, for example, 15-20 mm, but the present invention is not limited thereby.

It is preferable that the dust re-scattering prevention mechanism 32 further comprises an inclined side wall 320 as shown in FIG. 3, outside the plate bodies P1, P2 included in the outermost located re-scattering prevention unit 321 among the plurality of re-scattering prevention units 321.

In an upper re-scattering prevention unit group 32U, the slit S is not only formed between the lower edges of the plate bodies P1, P2 included in the re-scattering prevention units 321 adjacent to one another, but also between the outermost located re-scattering prevention unit 321 and the inclined side wall 320.

Moreover, the dust re-scattering prevention mechanism 32 preferably comprises the upper re-scattering prevention unit group 32U and a lower re-scattering prevention unit group 32L, formed by the plurality of re-scattering prevention units 321.

Further, the top T constituting the ridge line portion of each of the re-scattering prevention units 321 in the lower re-scattering prevention unit group 32L is preferably disposed, in a plan view, within a slit S formed in the upper re-scattering prevention unit group 32U.

The storage tank 33 shown in FIG. 3 has an inclined side wall 330 and stores dust that has passed through the dust re-scattering prevention mechanism 32.

The storage tank 33 may be configured to capture dust that has fallen from the dust capturing mechanism 31 when the dust re-scattering prevention mechanism 32 is omitted.

In addition, in the lower re-scattering prevention unit group 32L, the slit S is preferably also formed between the plurality of re-scattering prevention units 321 and the inclined side wall 330 of the storage tank 33, similar to the upper re-scattering prevention unit group 32U.

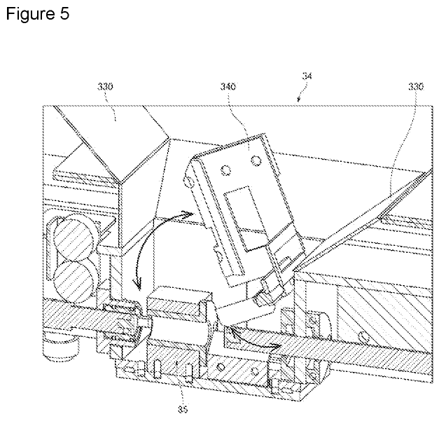

FIG. 5 illustrates the stirring mechanism 34 and the dust solidifying mechanism 35 in FIG. 1.

The stirring mechanism 34 shown in FIG. 5 is disposed beneath the storage tank 33.

Depending on the operation state of the dust solidification system 1, the re-scattering of dust, etc., the fume and spatter content rates in the dust stored in the storage tank 33 may fluctuate.

The stirring mechanism 34 comprises a stirring arm 340, and by for example, rotating the stirring arm 340, the dust stored in a lower part of the storage tank 33 is stirred and homogenized.

The dust that has been homogenized by stirring moves to the dust solidifying mechanism 35.

With the stirring mechanism 34, dust components can be homogenized with a simple structure and dust solidification can be performed stably.

In addition, when the dust is sufficiently solidifiable, such as when solidification-inhibiting substances have been sufficiently removed by the preduster 2, the stirring mechanism 34 may be omitted.

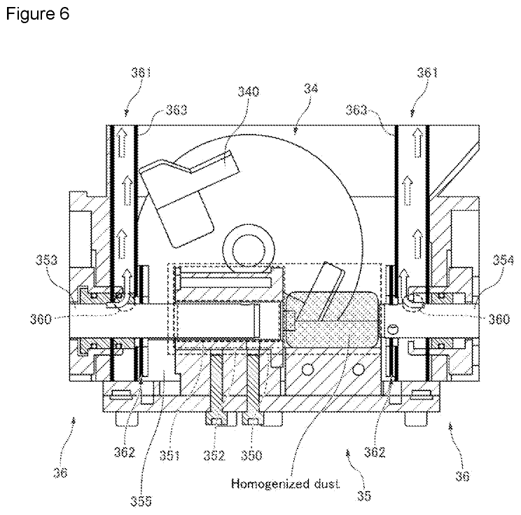

FIG. 6 illustrates the stirring mechanism 34, the dust solidifying mechanism 35, and the air releasing mechanism 36 in FIG. 1.

The dust solidifying mechanism 35 shown in FIG. 6 is disposed in a position where the dust stirred by the stirring mechanism 34 is stored.

The dust solidifying mechanism 35 solidifies the dust homogenized by the stirring mechanism 34 into a pellet-shape in a forming chamber 350.

The dust solidifying mechanism 35 comprises: a forming member 352 that is disposed in the forming chamber 350 and has a forming hole 351 provided therein; rods 353, 354; and a discharge hole 355.

The rod 354 is a pressurizing rod and is capable of advancing into and withdrawing from the forming hole 351.

The rod 353 is a closing rod and is stationary when a solidified product is formed.

The rod 353 pushes the homogenized dust in the forming chamber 350 into the forming hole 351, and by compacting the homogenized dust between a pressurizing surface of the rod 353 and a pressurizing surface of the rod 354 in the forming chamber 350, a pellet-shaped solidified product is formed.

The formed solidified product is held between the rod 353 and the rod 354, passes through the forming hole 351 together with the rod 353 and the rod 354, is conveyed to the discharge hole 355, and is discharged.

Here, although the rod 354 and the rod 353 have been described respectively as a pressurizing rod and a closing rod, the present invention is not limited thereby, and the rod 354 may be a closing rod, the rod 353 may be a pressuring rod, and the rods 353, 354 may both be capable of reciprocating.

In addition, the cross-sectional profile of the rods 353, 354 may be circular or may be polygonal, such as hexagonal.

The air releasing mechanism 36 releases air that flows into the storage tank 33 from the dust solidifying mechanism 35 due to the negative pressure to thereby prevent air from entering the forming chamber 350 and prevent the re-scattering of dust in the forming chamber 350 of the dust solidifying mechanism 35.

Moreover, although the relatively light-weight fumes scatter first when dust scatters, by preventing dust scattering, the solidification-inhibiting substance content rate in the formed solidified product can be suppressed.

The air releasing mechanism 36 comprises: a ventilation hole 360; an air releasing duct 361; a seal portion 362; and a partition 363.

The ventilation hole 360 is outside the forming chamber 350 and is provided on the pathway of the rods 353, 354.

The air releasing duct 361 has its interior in communication with the ventilation hole 360 and forms a withdrawal pathway for air that has flowed in from the pathway of the rods 353, 354.

The seal portion 362 is a member for easily sealing between the forming chamber 350 and the ventilation hole 360.

The partition 363 is a member that surrounds the air releasing duct 361 and is for ensuring the pathway of the air releasing duct 361.

The air releasing mechanism 36 may be omitted when there is little influence or no dust scattering in the forming chamber 350.

Next, the operation of the dust solidification system 1 will be described.

Operation of the fan 311 generates a negative pressure, and due to this negative pressure, dust is sucked into the preduster 2.

The sucked dust is classified by the preduster 2, and spatter, etc., which are solidification-inhibiting substances, are removed.

The removed spatter, etc. are collected by the solidification-inhibiting substance collecting unit 23 provided beneath the preduster 2.

Moreover, the remaining dust is transported from the preduster 2 to the dust collector 3 by the negative pressure.

The transported dust adheres to the filter 312.

The dust that has adhered is scraped off by the dust sweeping mechanism (not shown) and falls down to a lower part of the dust collector 3.

The dust falling down to a lower part of the dust collector 3 slides along the upper re-scattering prevention unit group 32U, the lower re-scattering prevention unit group 32L, and the inclined side wall 320, etc. of the dust re-scattering prevention mechanism 32, passes through the slits in the respective lower portions, and is stored in the storage tank 33 located beneath the dust re-scattering prevention mechanism 32.

The dust stored in the storage tank 33 is intermittently loaded into the stirring mechanism 34 located beneath the storage tank 33 and is stirred to make fumes and spatter homogeneous.

The stirred dust is loaded into the forming chamber 350 of the dust solidifying mechanism 35.

The dust loaded into the forming chamber 350 is compacted by the rods 353, 354 and is formed in a pellet-shaped solidified product.

At this time, the air in the forming chamber 350 is released by the air releasing mechanism 36.

The released air is discharged to the storage tank 33 via the ventilation hole 360, the air releasing duct 361, etc.

The dust that has been formed into a pellet shape is discharged from the discharge hole 355.

As explained above, with each configuration of the dust solidification system 1 according to the present embodiment, the following effects are obtained.

With the preduster 2, the content rate of spatter, i.e., a solidification-inhibiting substance, in the dust can be reduced.

With the dust capturing mechanism 31, the dust can be introduced and allowed to fall into the dust collector 3.

With the dust re-scattering prevention mechanism 32, the dust can be delivered to the storage tank 33 while reverse flowing of the dust due to re-scattering is prevented.

With the stirring mechanism 34, the dust can be homogenized at a lower portion of the storage tank 33.

With the dust solidifying mechanism 35, the homogenized dust can be solidified.

With the air releasing mechanism 36, the entry of air into the forming chamber 350 from the dust solidifying mechanism 35 can be prevented, the scattering of dust in the forming chamber 350 can be prevented, and the solidification-inhibiting substance content rate in the solidified product can be suppressed.

Thus, with the dust solidification system 1 according to the present embodiment, collected dust can be solidified with a high formability.

Moreover, according to the present embodiment, it is possible to perform all the treatments from the collection of dust to the solidification of the dust continuously in one system.

In addition, although a dust solidification system comprising: a preduster 2; a dust capturing mechanism 31; a dust solidifying mechanism 35; a dust re-scattering prevention mechanism 32; a storage tank 33; a stirring mechanism 34; and an air releasing mechanism 36 has been described in the present embodiment, the present invention is not limited thereby.

The dust re-scattering prevention mechanism 32, the stirring mechanism 34, and the air releasing mechanism 36 can be omitted as necessary, so long as one or more of these are provided.

In addition, although the exemplary explanations in the present embodiment related to a situation in which dust generated from a laser processing machine is solidified, the present invention is not limited thereby.

The present invention can be applied to solidification-inhibiting factor-containing dust, such as dust generated during welding or processing by a plasma processing machine.

### REFERENCE SIGNS LIST

1 Dust solidification system
2 Preduster
21 Dust introduction port
22 Classifying unit
23 Solidification-inhibiting substance collecting unit
3 Dust collector
31 Dust capturing mechanism
311 Fan
312 Filter
32 Dust re-scattering prevention mechanism
32U Upper re-scattering prevention unit group
32L Lower re-scattering prevention unit group
320 Inclined side wall
321 Re-scattering prevention unit
T Top
P1, P2 Plate bodies
S Slit
33 Storage tank
330 Inclined side wall
34 Stirring mechanism
340 Stirring arm
35 Dust solidifying mechanism
350 Forming chamber
351 Forming hole
352 Forming member
353, 354 Rod
355 Discharge hole
36 Air releasing mechanism
360 Ventilation hole
361 Air releasing duct
362 Seal portion
363 Partition

1. A dust solidification system for solidifying dust containing a fume and a solidification-inhibiting substance that has a greater mass and size than the fume, the dust solidification system comprising:
a preduster for sucking dust with a negative pressure generated by a negative pressure generating source, removing the solidification-inhibiting substance from the sucked dust, and making the dust with a reduced solidification-inhibiting substance content rate flow toward the negative pressure generating source;
a dust capturing mechanism for capturing the dust flowing from the preduster due to the negative pressure and allowing the dust to fall;
a storage tank for storing the dust captured by and falling from the dust capturing mechanism; and
a dust solidifying mechanism for solidifying the dust in a forming chamber;
and further comprising one or more of the following:
a dust re-scattering prevention mechanism for preventing re-scattering of the dust falling from the dust capturing mechanism;
a stirring mechanism for stirring the dust loaded into the dust solidifying mechanism; and
an air releasing mechanism for preventing air from entering the forming chamber by releasing air flowing into the storage tank from the dust solidifying mechanism due to the negative pressure.

2. The dust solidification system of claim 1, wherein
the dust re-scattering prevention mechanism comprises a plurality of re-scattering prevention units disposed adjacently in a direction traversing a direction in which the dust from the dust capturing mechanism falls, wherein
each of the plurality of re-scattering prevention units comprises a pair of plate bodies joined to form an inverted V-shape in a side view,
a ridge line portion, formed by the joining of the pair of plate bodies, is disposed facing the dust capturing mechanism above, and
a slit is provided in a portion along a lower edge of the plate bodies to allow the dust to pass through downward.

3. The dust solidification system of claim 2, wherein
the dust re-scattering prevention mechanism further comprises an inclined side wall outside the plate bodies included in an outermost located re-scattering prevention unit among the plurality of re-scattering prevention units, and
the slit is provided between lower edges of the plate bodies included in the re-scattering prevention units that are adjacent to one another and between the outermost located re-scattering prevention unit and the inclined side wall.

4. The dust solidification system of claim 3, wherein
the dust re-scattering prevention mechanism comprises: an upper re-scattering prevention unit group and a lower re-scattering prevention unit group, formed by the plurality of re-scattering prevention units, and
the ridge line portion of each re-scattering prevention unit in the lower re-scattering prevention unit group is, in a plan view, disposed in the slit formed in the upper re-scattering prevention unit group.

5. A dust solidification method for solidifying dust containing a fume and a solidification-inhibiting substance that has a greater mass and size than the fume, the dust solidification method comprising:
sucking dust with a negative pressure generated by a negative pressure generating source, removing the solidification-inhibiting substance from the sucked dust, and making the dust with a reduced solidification-inhibiting substance content rate flow toward the negative pressure generating source;
capturing the dust flowing due to the negative pressure and allowing the dust to fall;
storing the captured and falling dust in a storage tank; and
solidifying the dust by a dust solidifying mechanism in a forming chamber;
and further comprising one or more of the following:
preventing re-scattering of the falling dust by a dust re-scattering prevention mechanism;
stirring the dust loaded into the dust solidifying mechanism; and
releasing air flowing into the storage tank from the dust solidifying mechanism due to the negative pressure.
